(19) United States
(12) Patent Application Publication
(10) Pub. No.: US 2020/0215433 A1
(43) Pub. Date: Jul. 9, 2020

(54) Method and System for Remotely Streaming a Game Executing on a Host Computer System to a Remote Computer System

(71) Applicant: Rainway, Inc., Seattle, WA (US)

(72) Inventors: Aaron Ahmed, Edinburgh (GB); Andrew Sampson, Seattle, WA (US); Evan Banyash, Seattle, WA (US); Roman Ryltsov, Kharkov (UA)

(21) Appl. No.: 16/716,096

(22) Filed: Dec. 16, 2019

Related U.S. Application Data
(60) Provisional application No. 62/789,963, filed on Jan. 8, 2019.

(51) Int. Cl. A63F 13/34; G06N 5/00; G06F 16/44; H04N 21/44; H04N 21/478; H04N 21/439; H04N 21/2187; H04L 29/08; H04N 21/6437; H04N 21/431; H04N 21/234; H04N 21/233; A63F 13/23; A63F 13/358

(52) U.S. Cl. CPC A63F 13/34; A63F 2300/534; G06F 16/44; H04N 21/44004; H04N 21/4781; H04N 21/439; H04N 21/2187; H04L 67/104; H04N 21/6437; H04N 21/431; H04N 21/234; H04N 21/233; A63F 13/23; A63F 13/358; A63F 2300/1025; A63F 2300/408; G06N 5/003

(57) ABSTRACT

A system and method for remotely playing a game over a network includes receiving, at a host computer system, a request to remotely play a video game at a remote computer system. The method also includes launching the video game on the host computer system. Further, the method includes capturing video frames and audio data generated for the video game. Additionally, the method includes generating a multimedia stream based on the video frames and audio data captured for the video game. The method includes transmitting the multimedia to the remote computer system. The method also includes receiving, from the remote computer system, input data in response to the multimedia. The input data corresponds to user interaction with multimedia stream. The method includes translating the input data to game input for the video game.

### CROSS-REFERENCE TO RELATED APPLICATIONS

This application claims the benefit of U.S. Provisional Patent Application No. 62/789,963, filed Jan. 8, 2019, which is hereby incorporated by reference in its entirety.

### FIELD

The present disclosure relates generally to methods and systems for remotely network streaming a video game for play on a remote computer system.

### BACKGROUND

Presently, video games represent a large segment of software purchased and utilized by consumers. Today's video games are typically complex and require significant amounts of computer and graphics processing power and resources. As such, gamers typically utilize high-end gaming computer systems that include powerful CPUs and multiple graphics cards. These gaming systems, however, are desktop style computer systems that lack mobility. This limits the freedom of gamers to play video games in different settings. Thus, there is a need for a system leverages the power of gaming systems for remote game play.

### SUMMARY

In some implementations, a method for remotely playing a game over a network includes receiving, at a host computer system, a request to remotely play a video game at a remote computer system. The method also includes launching the video game on the host computer system. Further, the method includes capturing video frames and audio data generated for the video game. Additionally, the method includes generating a multimedia stream based on the video frames and audio data captured for the video game. The method includes transmitting the multimedia to the remote computer system. The method also includes receiving, from the remote computer system, input data in response to the multimedia. The input data corresponds to user interaction with multimedia stream. The method includes translating the input data to game input for the video game.

Additionally, in some implementations, a computer readable medium storing instructions for causing one or more processors to perform a method for remotely playing a game over a network. The method includes receiving, at a host computer system, a request to remotely play a video game at a remote computer system. The method also includes launching the video game on the host computer system. Further, the method includes capturing video frames and audio data generated for the video game. Additionally, the method includes generating a multimedia stream based on the video frames and audio data captured for the video game. The method includes transmitting the multimedia to the remote computer system. The method also includes receiving, from the remote computer system, input data in response to the multimedia. The input data corresponds to user interaction with multimedia stream. The method includes translating the input data to game input for the video game.

Additionally, in some implementations, a method for identifying games for remote play over a network includes scanning one or more storage locations associated with video games on a remote computer system. The method also includes identifying a potential video game based on the scan. Further, the method includes determining launch parameters from data associated with the potential video game. Additionally, the method includes determining a human-readable title from the data associated with the potential video game. The method also includes retrieving information associated with the potential video game based on the human-readable title and the launch parameters. Further, the method includes identifying the potential video game as an actual video game based on the information retrieved from the potential video game.

### BRIEF DESCRIPTION OF THE DRAWINGS

The present disclosure will become better understood from the detailed description and the drawings, a brief summary of which is provided below.

FIG. 1A illustrates a block diagram of an example of a network environment in which game play can be streamed from a host computer system to a remote computer device, according to various implementations.

FIG. 1B illustrates a block diagram of an example of a dashboard for facilitating remote streaming of game play from a host computer system to a remote computer device, according to various implementations.

FIG. 2 illustrates an example of a method for remote streaming of game play a host computer system to a remote computer device, according to various implementations.

FIG. 3 illustrates an example of a graphical user interface for displaying and selecting games that are available for streaming, according to various implementations.

FIG. 4 illustrates an example of a method for identifying games available for remote streaming, according to various implementations.

FIG. 5 illustrates an example of a computer system, according to various implementations.

### DETAILED DESCRIPTION

For simplicity and illustrative purposes, the principles of the present teachings are described by referring mainly to examples of various implementations thereof. However, one of ordinary skill in the art would readily recognize that the same principles are equally applicable to, and can be implemented in, all types of information and systems, and that any such variations do not depart from the true spirit and scope of the present teachings. Moreover, in the following detailed description, references are made to the accompanying figures, which illustrate specific examples of various implementations. Logical and structural changes can be made to the examples of the various implementations without departing from the spirit and scope of the present teachings. The following detailed description is, therefore, not to be taken in a limiting sense and the scope of the present teachings is defined by the appended claims and their equivalents.

In addition, it should be understood that steps of the examples of the methods set forth in the present disclosure can be performed in different orders than the order presented in the present disclosure. Furthermore, some steps of the examples of the methods can be performed in parallel rather than being performed sequentially. Also, the steps of the examples of the methods can be performed in a network environment in which some steps are performed by different computers in the networked environment.

Some implementations are implemented by a computer system. A computer system can include a processor, a memory, and a non-transitory computer-readable medium. The memory and non-transitory medium can store instructions for performing methods and steps described herein.

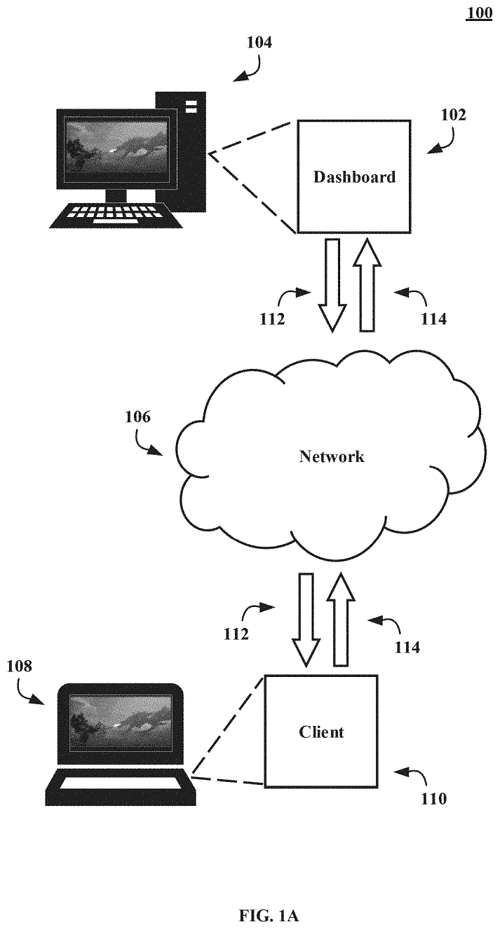

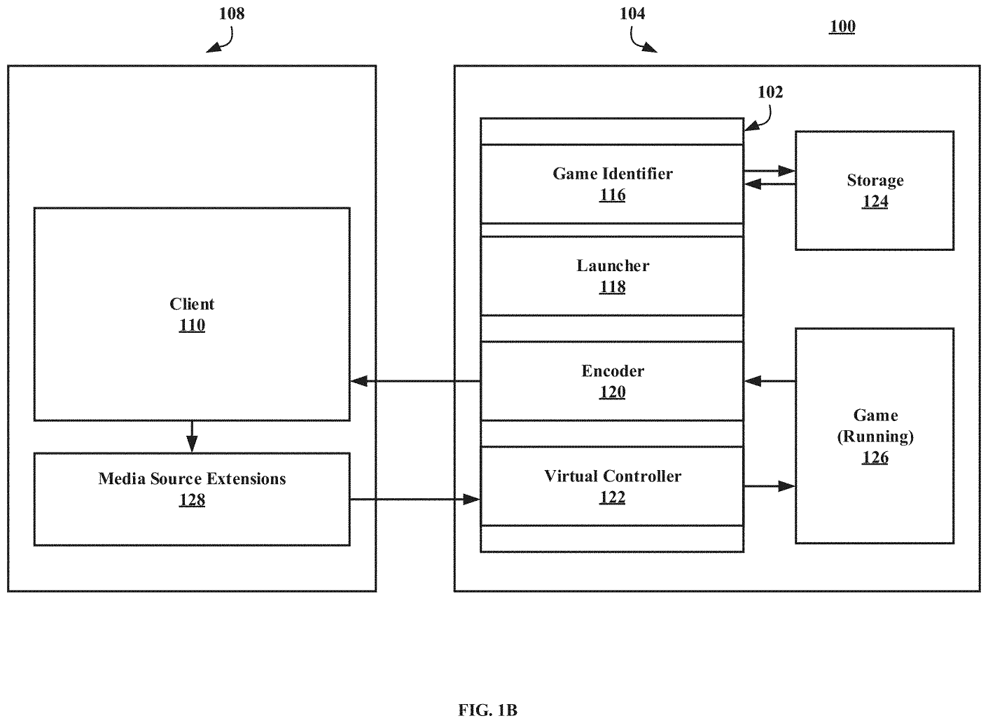

FIG. 1A is a block diagram illustrating an example of a network environment 100 in which game play can be streamed from a host computer system to a remote computer system, according to various implementations. While FIG. 1A illustrates various components contained in the network environment 100, FIG. 1A illustrates one example of a network environment and additional components can be added and existing components can be removed.

As illustrated in FIG. 1A, a dashboard 102 is installed on a host computer system 104. The dashboard 102 enables remote game play, over a network 106, for games available and running on the host computer system 104. For example, a remote computer system 108 can remotely play a game hosted on the host computer system 104 using a client 110. In some implementations, the client 110 can be a network browser (e.g., web browser), media browser (e.g., video player), etc.

In implementations, when a user connects to the dashboard 102 with the client 110, the dashboard 102 generates a graphical user interface (GUI) that presents a list of games available to remotely play on the remote computer system 108. To generate the GUI, the dashboard 102 performs a discovery process on the host computer system 104 and identifies games that can be launched on the host computer system 104 and streamed to the remote computer system 108. To identify the games, the dashboard 102 scans storage locations in the host computer system 104 that are typically associated with games. For example, the dashboard 102 can scan a registry, file paths commonly associated with games, databases associated with games, and software libraries (e.g., dynamic linked libraries (DLLs)) associated with games. In some implementations, the dashboard 102 can perform a heuristic search. The games identified by the dashboard 102 include games stored on the host computer system 104 and games available through game streaming services such as Steam, Origin, UPlay and GOG Galaxy.

The GUI generated by the dashboard 102 can include an indication (visual and/or textual) of the games available for remote play and an active link for a user to initiate game play. For example, the games can be presented as cards in a grid, with a title related banner as the background of each, as discussed further below. The indication provided in the GUI can be an interactive widget that provides additional information about the game. For example, as a pointing device (e.g., cursor) hovers over one of the game cards, additional information can be presented, for example, the game title, a short description, playtime statistics, a slideshow of screenshots from the game, or a relevant video etc. The GUI, generated by the dashboard 102, can also include menus and links to access other features of the dashboard 102. The other features can include settings and configuration for the dashboard 102, controller settings for input, a game rating feature, a chat feature, etc.

In implementations, once a user selects to play a game, the dashboard 102 launches the game on the host computer system 104. To launch the game, the dashboard 102 can store and utilize launch parameters and access information for the game that are determined during the discovery process, as discussed further below. Once the game begins executing on the host computer system 104, the dashboard 102 captures image data (e.g., image frames) that are transmitted to a display device (e.g., monitor) of the host computer system 104. Likewise, the dashboard 102 captures audio data transmitted to audio devices (e.g., speakers, headphones, etc.) of the host computer system 104. As the image data and audio data is captured, the dashboard 102 generates a game multimedia stream based on the captured image data and audio data.

In implementations, the dashboard 102 generates a remote encoding pipeline and prepares a video feed and an audio feed based on the captured image data and audio data. The dashboard 102 can generate a series of packets for the video feed and audio feed (multimedia stream) for transmission to the remote computer system 108. Once generated, the dashboard 102 transmits the series of packets to the client 110, via the network 106. In some implementations, the video feed and the audio feed can be multiplexed as a multimedia stream. In some implementations, the video feed and the audio feed can be transmitted over separate channels.

In implementations, to receive the data, the remote computer system 108 connects to the dashboard 102 using a media exchange protocol. In some implementations, the client 110 can connect to the dashboard 102 using Web Real-Time Communication (WebRTC) and can exchange data using WebRTC data channels. In some implementations, the client 110 can connect to the dashboard using Web Sockets.

As the packets are received, the client 110 decodes the packets and reconstructs the video feed and audio feed using media codecs. In some implementations, the client 110 can forward the data to the Media Source Extensions Application Programming Interface (MSE API). Once decoded, the client 110 plays the video on a display device (e.g., monitor, device screen, etc.) of the remote computer system 108 and plays the audio on an audio device (e.g., speaker, headphones, etc.) of the remote computer system 108.

In implementations, as the client 110 plays the video and audio stream, the user of the remote computer 108 inputs movements as if the user was playing the game. The client 110 captures the input device (e.g., keyboard, mouse, game controller, etc.) input from events (e.g., browser events). The client 110 relays the input device input to the dashboard 102, and, in response, the dashboard 102 applies the input device input directly to the game executing on the host computer system 104. In some implementations, if the client is a web browser, game controller input can be captured via the hypertext markup language (HTML) version 5 gamepad API, and, at the remote computer system 108, a virtual controller can used to emulate the inputs on the host computer system 104.

In some implementations, the client 110 and the dashboard 102 can capture and apply mouse input via two modes: absolute and relative. In absolute mode, the client 110 can send the absolute coordinates of every new mouse position as the cursor is moved. In relative mode, the client 110 can capture the cursor position, hide the cursor from view, and send every mouse movement to the dashboard 102, in relative form. When the cursor is captured, the client 110 can attempt to predict the location of the remote cursor. The prediction can be achieved by adding all the relative movements sent since the cursor was captured to the starting position. Then, the client 110 can draw a relative cursor at the predicted position. The dashboard 102 can send the location of the remote cursor periodically so that the remote cursor position can be periodically corrected to match the client 110 version of the cursor. When the cursor is not visible, such as in controlling a first person shooter game, the cursor can be hidden entirely and no prediction or correction techniques is required.

In implementations, one or more of the components of the dashboard 102 and the client 110 can be implemented as software programs or modules that perform the methods, process, and protocols described herein. The software programs or modules can be written in a variety of programming languages, such as JAVA, C++, C#, Python code, Visual Basic, hypertext markup language (HTML), extensible markup language (XML), and the like to accommodate a variety of operating systems, computing system architectures, etc.

The host computer system 104 can be any type of computer system capable of communicating with and interacting with the dashboard 102, the remote computer system 108, and the client 110, and performing the process and methods described herein. As described herein, the host computer system 104 can include any of a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise).

The remote computer system 108 can be any type of computer system capable of communicating with and interacting with the dashboard 102, the host computer system 104, and the client 110, and performing the process and methods described herein. As described herein, the remote computer system 108 can include any of a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise).

The network 106 can include local area networks (LANs), wide area networks (WANs), telephone networks, such as the Public Switched Telephone Network (PSTN), an intranet, the Internet, or a combination thereof. It should be understood that where the terms server or computer system are used, this includes the use of networked arrangements of multiple devices operating as a server or computer system. For example, distributed or parallel computing can be used.

FIG. 1B illustrates an example of the dashboard 102 for facilitating remote streaming of game play from a host computer system to a remote computer device, according to various implementations, according to various implementations. While FIG. 1B illustrates various components contained in the dashboard 102, FIG. 1B illustrates one example of a dashboard and additional components can be added and existing components can be removed.

As illustrated, the dashboard 102 includes a game identifier 116, a launcher 118, and encoder 120, and a virtual controller 122. The dashboard 102 is configured to execute on the host computer system 104 in order to provide remote game play to the remote computer system 108.

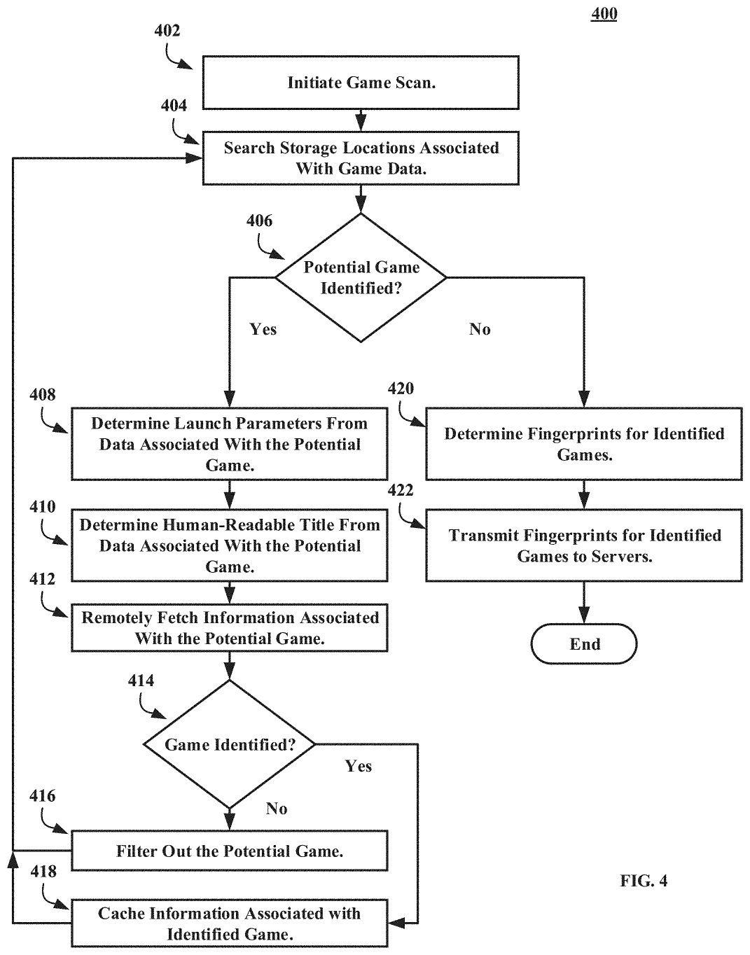

The game identifier 116 is configured to identify games that are available for play on the host computer system 104 and remote play on the remote computer system 108. The game identifier is configured to perform a discovery process on the host computer system 104. The discovery process scans the host computer system 104 in order to identify games that can be launched on the host computer system 104 and streamed to the remote computer system 108. To identify the games, the game identifier is configured to scan storage locations in the host computer system 104 that are typically associated with games. For example, the dashboard 102 can scan a registry, file paths commonly associated with games, databases associated with games, and software libraries (e.g., dynamic linked libraries (DLLs)) associated with games, as discussed before with reference to FIG. 4.

The launcher 118 is configured to launch a game 126 that has been selected by user at the remote computer system 108. The launcher 118 can be configured to retrieve the launch and access parameters determined by the game identifier 116 and launch the game 126 selected by the user.

The encoder 120 is configured to capture image data and audio data for the game 126 running on the host computer system 104. The encoder 120 is also configured to generate the game multimedia stream from the captured image data and audio data and provide the multimedia stream to the client 110. The encoder 120 include one or more software modules and software libraries to implement the services to capture the image data and audio data and generate the multimedia stream.

For example, the encoder 120 can provide a DesktopCapture service for capturing image data sent to the display device of the host computer system 104. The DesktopCapture service can be built into a desktop capture DLL (e.g., DesktopCapture.dll) and can be consumed as in-process library by the dashboard 102. In some implementations, the desktop capture DLL can be built using Component Object Model (COM) technology and enables easy integration with other software items, including and specifically by means of automatic interoperation with .NET environment. In some implementations, the components of the dashboard 102 (and other applications) can be developed in C#, and the desktop capture DLL can consume generated data using standard lightweight interoperation, with the complexity of interaction with native operating system (OS) APIs, such as Desktop Duplication, Direct3D, Media Foundation, Windows Audio Session, hardware vendor specific software development kits (SDKs), hidden by the desktop capture DLL. In some implementations, the DesktopCapture services can include four services covered by DesktopCapture, Session, Multiplexer classes, respectively and supplementary services. Together the DesktopCapture, Session, Multiplexer classes can cover, end to end, the process of video and audio capture of content of a specific display device (e.g., game video output) and audio device (e.g., game audio output) with the generation of a stream of data compatible with multimedia streaming (e.g., web streaming). The Desktop Capture class can provide enumeration of video and audio inputs, library defined supplementary functionality (e.g., logging management, performance telemetry), and session creation. The session class can provide display device capture session management. The multiplexer class can provide video and audio processing, encoding, and multiplexing services. The supplementary services can include web server integration, reference output generation, Media Foundation primitives.

In some implementations, the Desktop Capture service can manage communication to APIs and software libraries. The APIs and software libraries can include Windows APIs such as Desktop Duplication, Direct3D versions 11, 12, Media Foundation, Windows Audio Session API (WASAPI); third party libraries such as Opus, WebM; and vendor specific SDKs such as NVIDIA Video Codec SDK, AMD Advanced Media Framework (AMF) SDK, Intel Media SDK.

In some implementations, the DesktopCapture class can provide high level services of an API such as detection and enumeration of available capture devices (e.g., monitors, video encoding options, audio input devices, audio output devices to capture in loopback mode). Also, the DesktopCapture class can enumerate video encoding options with additional information on hardware affinity and support for cross-adapter data transfer capabilities. For example, a typical setup of the DesktopCapture class can allow the dashboard 102 to choose a display device of interest where the game 126 is presented, an audio endpoint device typically used for audio output by game 126, respective hardware video encoding option, and then can offer session creation services.

In some implementations, the Session class can implement the requirements of video capture from display device operating to present video content of the game 126, including high activity dynamic content due to interaction with the game 126. The Session class can operate to run video capture as a desktop duplication session with immediate real-time data shaping to meet needs of multimedia streaming over the network 106. Additionally, to convert the video feed to requested fixed rate stream, the Session class can handle intermittent duplication outages, for example, taking place during re-initialization of the underlying devices and hardware. The Session class can manage multiple related technologies in order to generate consistent video feed for the multimedia stream.

In some implementations, the session class can be activated for specific display device (e.g., monitor), and can internally communicates with Windows OS DXGI services to setup Desktop Duplication service and capture video content as by the hardware of the host computer system 104. The Session class can duplicate the video feed and convert it to requested video properties while maintaining minimal processing latency. The Session class can provide video processing such automatically scaling the captured content to a requested resolution, cropping rather than scaling, etc. The Session class can shape the display device updates to produce a fixed frame rate feed as needed for generating the multimedia stream. The Session class can also provide video pointer tracking services such as pointer visibility, position and shape tracking as video is being captured; blending the shape into captured video and/or tracking the pointer shape properties separately to re-create the shape as needed on the remote computer system 108. The Session class also provides video overlay services such as blending diagnostic or otherwise configurable information to video frame as the video frame is being produced.

The Session class can implement a desktop duplication capture loop that continuously pulls display device (e.g., monitor) frames with updates in the form of DirectX Graphics Infrastructure (DXGI/D3D11) textures along with pointer update information. The loop can be tolerant to API failures related to re-initialization of the hardware device and attempts to handle hardware device state changes transparently. Once a video frame is captured, the data is contained in an ephemeral texture where the service takes a copy of data (e.g., copies, scales or crops depending on context) from into a long lasting texture from managed texture loop. The Session class can manage an additional compatible Direct3D 11 device to reduce interference between capture activity and Desktop Duplication API. The Session class can automatically synchronize the captured data between the hardware devices along with data processing. In respective modes of operation, the Session class additional processing steps of blending pointer shape into captured frame and/or textual overlay data. The resulting texture can be exposed as a new frame for produced video feed for the multimedia stream. The Session class can record runtime metrics at certain steps of the processing and can attach diagnostic information to video frame data so that the data could be embedded into resulting multimedia stream.

In some implementations, the Multiplexer class can implement real-time media processing pipeline, which connects to video capture class to consume video stream from Desktop Duplication API. The Multiplexer class can also implement audio capture and, on the downstream end, produces a compressed a multiplexer media stream per requests and configuration of the client 110. The Multiplexer class can build a media pipeline around Media Foundation API, which specifically can define the infrastructure and individual software components and provide supplementary APIs such as Real-Time Working Queue (RTWQ) API and Multimedia Class Scheduler Service (MMCSS). The Multiplexer class, in general, can be designed to remain compatible with Media Foundation API as a foundation, and also maintain the internal implementation components (primitives) compatible with Media Foundation API for the purpose of interoperability and ease of pipeline restructure. The Multiplexer class can eliminate some use of stock OS components that do not provide flexibility for performance reasons. The Multiplexer class can provide data multiplexing services. The multiplexing services can produce chunks of data bitstream in a format defined by the configuration of the service. The format can be network (e.g., web) compatible so that the dashboard 102 route the data with minimal alterations via the network 106 to the client 110 leveraging MSE technology.

The typical setup for the Multiplexer class can define media output such as video and audio real-time streams generated independently without direct synchronization between them. The video stream can be encoded in a H.264 (MPEG-4 Part 10) format and packaged as MP4 (MPEG-4 Part 14) stream structured as fragmented MP4. The video stream generation flexibility can include variable (adaptive) bitrate wherever supported by underlying encoder and options to quickly restart encoding with new format restarting with new MP4 file data. Audio can be encoded with Opus low latency codec packaged as WebM/Matroska stream. Additional audio encoding options can include AAC (MPEG-4 Part 3), MP3, raw Opus, Opus in Ogg container. The Multiplexer class can include additional options to multiplex H.264 video and AAC audio into joint FMP4 stream. Additionally to media stream data, the Multiplexer class issues error and reset notifications responding to events of the data sources.

Even though the Media Foundation primitives are connected together as defined and designed by Media Foundation Media Session API, the Multiplexer class can implement a replacement of Media Session foundation and can implement custom resolution of the topologies in order to provide minimal overhead and fine control over processing steps. The customized implementation of the Multiplexer class also can address a lack of standard capabilities of profiling and registering telemetry data. The internal implementation of Media Session can follow the design of original API and can mimic aspects of topology resolution, events, cooperation with RTWQ API, asynchronous processing model. The Media Session implementation can target real-time processing, support for multiple DXGI device managers, and attaching telemetry information to the data. The Media Session implementation can implement extended capabilities to track telemetry data attached to samples as data flows through the pipeline, and can record its own telemetry data about the topology and state of internal buffers. A Fragmented MP4 (FMP4) sink primitive can be responsible for retrieving collected data and converting the data to embeddable state, so that the telemetry data can be transparently added to the produced output. The Media Session implementation can attach collected data to the payload stream and the performance data can be both recorded with the playable content and retrieved on the client 110, live.

The Multiplexer class can implement both synchronous and asynchronous media foundation transforms. The Media Session implementation can implement an internal synchronous-to-asynchronous adapter to enable use of stock and third party legacy Media Foundation Transforms (MFTs) as asynchronous transforms. The asynchronous transform can convert legacy synchronous Media Foundation Transforms (MFT) to asynchronous primitives. When the dashboard 102 attempts to build a pipeline using an MFT software item which appears to be a synchronous MFT, the dashboard 102 can utilize the asynchronous transform to wrap synchronous transform in question and expose its functionality via newer asynchronous transform interface. In some implementations, the Multiplexer class can implement an internal version of D3D11 Video Processor API wrapper in a dual synchronous/asynchronous MFT form factor standard, and can implement an audio encoder as Opus library wrapper in the form of asynchronous MFT. The Multiplexer class can also perform audio format conversions and resampling in order to fit audio formats and handle an audio resampling MFT that is a synchronous implementation. The synchronous-to-asynchronous transform enables use of full range of MFT primitives shipped with legacy operating system such as the Windows operating systems including those introduced before Windows Vista and those introduced later but designed with legacy interface.

The Multiplexer class can implement an import texture transform that addresses the task of pipeline simulation where video streams and frames originate from hardware other than a graphics processing unit (GPU) subsystem. The production pipelines have video frames coming from GPU subsystem, and the encoder 120 can receive duplicated desktop images hosted by textures in video memory. The import texture transform can offer the functionality of uploading video data into GPU textures and stream the video frames further with delivery of video memory backed data. The import texture transform is capable to address Media Foundation pipelines with multiple GPU and D3D11 device references. Traditional advanced Media Foundation pipelines technically allow use of multiple GPUs, such scenarios require low level interaction with internal primitives to initialize specific D3D11 device. The import texture transform can be used in simulation pipelines traditional to Media Foundation API as well as extend simulation to build multi-GPU pipelines, such as those required to run tests on Direct3D 12 cross device texture transfer transform.

The Multiplexer class can implement a video processor wrapper transform. The video processor wrapper transform can be designed to both analyze operation of standard Video Processing MFT and expand its limitations. The video processor wrapper transform can wrap a standard implementation internally and exposes a similar external interface capable of intercepting communications and respectively updating the data.

In some implementations, the video portion of media processing pipeline provided by the encoder 120 can include video source converting of Desktop Duplication API data and output of the Session class described above to Media Foundation pipeline data. The video portion can also include optional cross device texture transfer to utilize secondary GPU processing capabilities. The video portion can also include optional video scaling, shaping of video frames on encoder input to normalize produced encoded output. The video portion can also include video compression services: hardware-assisted with and without use of vendor specific SDKs and fallback software encoder option. The video portion can also include video multiplexing.

In some implementations, the DesktopCapture services can implement a Media Foundation media source primitive which acts as data injection point for Desktop Duplication API captured data and the Session class described above. The primitive can capture generated video frames, typically scaled and with overlays applied as needed, and can ingest the video frames into pipeline for encoding and other data processing.

In some implementations, the DesktopCapture services can implement a Media Foundation transform to transfer video frames between GPUs in heterogeneous multi-adapter system (cross device transfer transform). The primitive can extend Media Foundation concept and can implements support for multiple Direct3D adapters and DXGI managers in a Media Foundation topology/pipeline. The cross device transfer transform can implement a texture-to-texture data copy by mapping the textures into CPU addressable space and performing CPU data copy. The cross device transfer transform can include several code paths to potentially apply more sophisticated and more performance efficient transfers. The cross device transfer transform can utilize SSE and AVX instructions, as well as streaming SIMD instruction set optimized for uncached software write combining (USWC) RAM.

In some implementations, the DesktopCapture services can implement a Media Foundation transform which utilizes Direct3D 12 API to transfer video frames between GPUs in heterogeneous multi-adapter system (Direct3D transfer transform). Similarly to cross device transfer transform, the Direct3D transfer transform can implement a transform using two Direct3D devices. The Direct3D transfer transform can implement a texture to texture copy of the data. The Direct3D transfer transform can internally manage a set of related Direct3D 11 and 12 devices with data taken through the devices. The Direct3D transfer transform can address the tasks of doing GPU-to-GPU transfer eliminating CPU access to data and data copy to system memory, and producing a copy of raw video data in secondary GPU video memory space to enable hardware encoder of secondary GPU to handle video compression. The Direct3D transfer transform can copy data between Direct3D 11 device textures specifically because Desktop Duplication API can be implemented on Direct3D 11 API only, and video encoders both Media Foundation and vendor specific SDK based are offering Direct3D 11 as a GPU binding point. Heterogeneous multi-adapter data can use Dircet3D 12 functionality, so the transfer implements a multi-step operation to copy the data. This also Direct3D 11/12 interoperability, GPU texture and buffer copy operations, and use of GPU copy engine to transfer data between GPUs.

In some implementations, the DesktopCapture services can implement a Media Foundation transform capable of scaling, format conversion, and other processing of media data (video processor transform). The video processor transform can wrap the Direct3D 11 Video Processor API in a similar way to a standard Video Processor MFT. Unlike standard implementations, the video processor transform can offer the ability to blend additional overlay and provides finer control over processor output. Additionally, the video processor transform can add support for asynchronous processing model. The video processor transform can be dual-purposed and participates both as synchronous processor before the data is ingested to Media Foundation pipeline, and can also act as optional asynchronous transform for scaling and/or format conversion as required for tasks of video format fitting.

In some implementations, the DesktopCapture services can implement a Media Foundation transform capable of updating and duplicating video frames thereby addressing video stream shaping for real-time streaming needs (frame rate normalization transform). The frame rate normalization transform can efficiently absorb input frame stream feed gaps and produce output formatted to contain no gaps thereby reducing browser glitches. In case of intermittent shortage of input data, the frame rate normalization transform can duplicate the last good known frame or can insert blackness in order to continue data generation.

In some implementations, the DesktopCapture services can implement a Media Foundation H.264 video encoder transform based on NVIDIA Video Codec SDK (NVIDIA transform) in order to compress video data in efficient way. NVIDIA transform can provide superior encoding services addressing needs of real-time streaming. The NVIDIA transform can provide an encoder that is free from issues related to NVIDIA GPU as secondary adapter (inability to use related encoder, resource leakage) and provide low processing overhead. The NVIDIA transform can provide the ability to apply SDK defined fine tuning and low latency profile. The NVIDIA transform can provide elimination of data copy on encoder input, support for additional input formats (ARGB32 as produced by Desktop Duplication API), and support for real-time target bitrate re-configuration implementing adaptive bitrate streaming.

In some implementations, the DesktopCapture services can implement a Media Foundation H.264 video encoder transform (AMD transform) based on AMD AMF SDK in order to compress video data in efficient way. The AMD transform can provide superior encoding services addressing needs of real-time streaming application that is free from issues related to synchronization of keyed mutex enabled input textures. The AMD transform can provide elimination of data copy on encoder input and the ability to apply SDK defined fine tuning. The AMD transform can provide support for real-time target bitrate re-configuration implementing adaptive bitrate streaming.

In some implementations, the DesktopCapture services can implement a Media Foundation H.264 video encoder transform (INTEL transform) based on Intel Media SDK in order to compress video data in efficient way. The INTEL transform can provide superior encoding services addressing needs of real-time streaming application that is free from issues related to synchronization of keyed mutex enabled input textures. The INTEL transform can provide elimination of data copy on encoder input and the ability to apply SDK defined fine tuning. The INTEL transform can provide support for real-time target bitrate re-configuration implementing adaptive bitrate streaming.

In some implementations, the DesktopCapture services can implement a Media Foundation media sink primitive to produce fragmented MP4 (FMP4) bitstream suitable for real-time streaming (fragmented transform). The fragmented transform can address real-time aspect of streaming and addresses problems where a stock multiplexer appears to be a not a good fit, for example, browser compatibility of FMP4 output data. The fragmented transform can provide packaging of fragments of video/audio data in fractions resulting in low playback latency. The fragmented transform can provide the ability to multiplex H.264 video and AAC audio (experimental) and the ability to restart media stream packaging on video format change starting new FMP4 stream immediately without stream data loss. The fragmented transform can also provide embedding collected telemetry data into H.264 feed by means of adding H.264 Annex D SEI NAL unit data with user data as defined in “User data unregistered SEI message semantics” section. The data can include of key/value pairs as defined internally by DesktopCapture service.

The Audio portion of media processing pipeline provided by the encoder 120 can include audio capture (e.g., loopback capture media source or alternatively stock Media Foundation, or source for specific WASAPI audio endpoint). The audio portion can include audio format conversion/fitting, audio encoding, and audio multiplexing. The DesktopCapture service can include an option to combine multiple video and audio into combined multi-track stream. The DesktopCapture service can implement a Media Foundation primitive to real-time loopback capture audio data from existing WASAPI endpoint. The primitive can provide minimal overhead capture in data chunks as provided by operating system (esp. 10 milliseconds) and can implement automatic silence insertion in order to produce a continuous stream of data from non-silent audio sequences mixed by WASAPI and provided via loopback capture functionality. The DesktopCapture service can use Opus library wrapper and can implement a Media Foundation audio encoder transform that provides latency, minimal length and latency frames and flexible bitrate as configured by the dashboard 102.

The DesktopCapture service can implement decoding of Opus audio. The audio decoder transform can implement an Opus library decoding functionality that matches production encoder and can be used for internal testing and quality assurance purposes. The decoder enables ability to build encoder-decoder pipelines, including non-live. The DesktopCapture service can use libwebm library to implement a Media Foundation sink primitive in order to format encoded Opus audio stream for web and MSE delivery.

The DesktopCapture service can implement a media sink. The media sink can address the problem of extraction of media data from Media Foundation pipeline in a performance efficient way. The media sink can provide raw data delivery without specific data formatting to handle real-time audio encoding in MP3, raw AAC, and raw Opus formats. The media sink can terminate media processing chains by accepting payload media data and delivering it to byte stream or potentially exposing it via an application defined callback.

In some implementations, the encoder 120 can also provide a cross-process property store to interact with helper interactive processes (e.g., OSD and hotkey responses). The library implements a subsystem that manages cross-platform data storage with a collection of general purpose values with performance efficient access. In some implementations, the library can be standalone external utility that monitors keyboard activity and captures specific hotkeys to convert them to these cross-process property store values.

In some implementations, the encoder 120 can also provide a cross-process storage to share produced bitstreams live. The library can implement an option to duplicate encoded H.264 video stream in a cross-process data storage so that a standalone external application could consume the data in a customized player accessing the live encoded data with minimal overhead.

In some implementations, the encoder 120 can also provide recording static reference output using video primitives (e.g., for testing purposes). The production scenario can be desktop capture, encoding and delivery in network ready format. Development, testing and maintenance tasks can require additional scenarios including ability to compose the internally developed primitives into development friendly pipelines. Reference output class can be a helper subsystem capable to use H.264 encoders to produce deterministic reference video files.

In some implementations, the encoder 120 can also provide a built-in RTP server. The subsystem can implement a tee from output of H.264 encoder that broadcasts video data using RTP UDP in a RFC friendly way and can consume the stream locally or remotely with a crafted configuration for VLC application.

In some implementations, the encoder 120 can also provide a built-in integration with HTTP Server API. The subsystem can duplicate encoded FMP4 output and expose it using HTTP API interface as streamable content consumed in a non-MSE way.

The virtual controller 122 can be configured to capture input device (e.g., mouse, game controller, etc.) inputs at the client 110 and apply the input to the game 126 running on the host computer system 104. The virtual controller can be configured to apply the input via two modes: absolute and relative. For example, in absolute mode, the client 110 can send the absolute coordinates of every new mouse position as the cursor is moved to the virtual controller 122. The virtual controller can be configured to apply the absolute coordinates to the movement in the game 126.

In relative mode, for example, the client 110 is configured to capture the cursor position, hide the cursor from view, and send every mouse movement to the dashboard virtual controller, in relative form. When the cursor is captured, the client 110 is configured to predict the location of the remote cursor. The prediction can be achieved by adding all the relative movements sent since the cursor was captured to the starting position. Then, the client 110 is configured to draw a relative cursor at the predicted position. The virtual controller 122 can be configured to send the location of the remote cursor periodically so that the remote cursor position can be periodically corrected to match the client 110 version of the cursor. When the cursor is not visible, such as in controlling a first person shooter game, the cursor can be hidden entirely and no prediction or correction techniques are required. The virtual controller 122 is described in further detail in U.S. Provisional Application No. 62/789,965, entitled “Method and System for Encoding Game Video and Audio Remotely Streamed to a Remote Computer System” to Ahmed et al. and filed on Jan. 8, 2019, the entire contents of which are incorporated herein by reference.

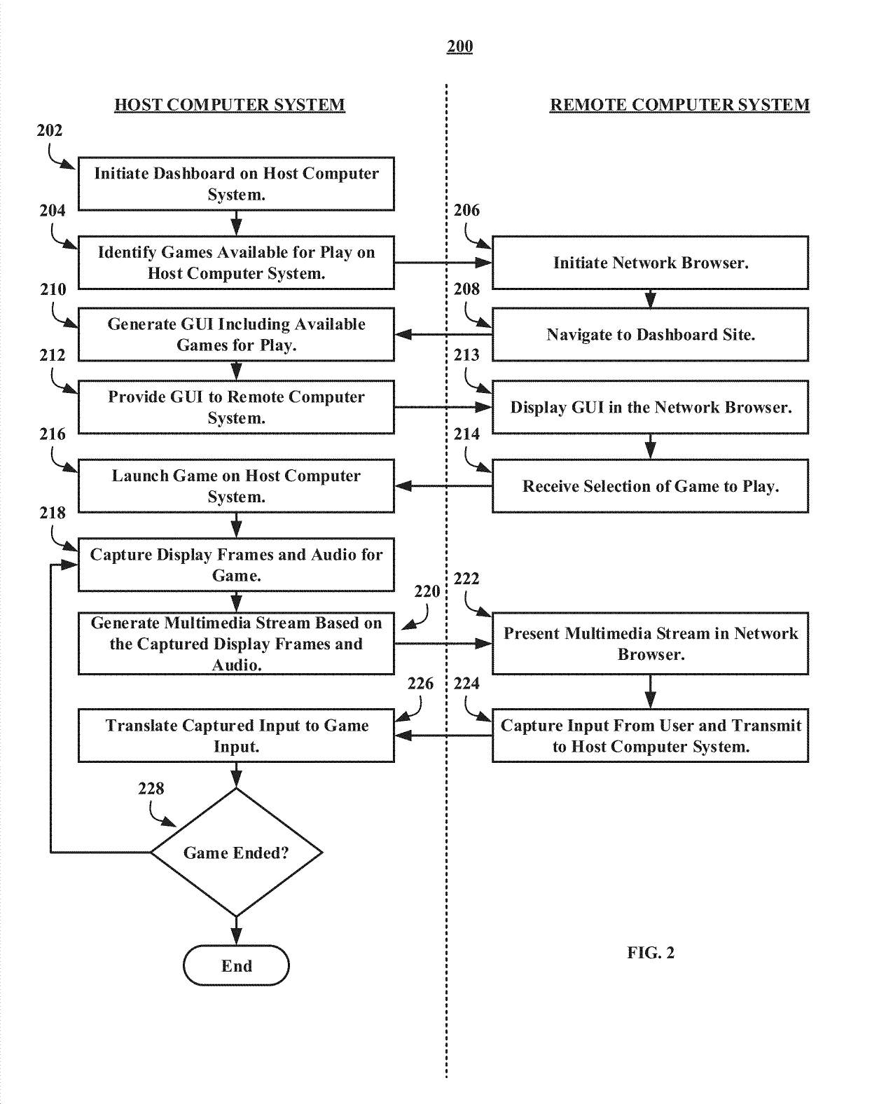

FIG. 2 illustrates an example of a method 200 for remotely playing a game over a network, according to various implementations. While FIG. 2 illustrates various stages that can be performed, stages can be removed and additional stages can be added. Likewise, the order of the illustrated stages can be performed in any order.

In 202, the dashboard is initiated on a host computer system. In implementations, a user can install the dashboard 102 on the host computer system 104. Once installed, in some implementations, the dashboard 102 can automatically launch when the host computer system 104 is booted. In some implementations, a user can launch the dashboard 102 on the host computer system.

In 204, games available for play on the host computer system are identified. In some implementations, the games can be identified when the dashboard 102 is installed on the host computer system 104. In some implementations, the games can be identified or updated when the dashboard is launched.

For example, the dashboard 102 can perform a discovery process on the host computer system 104 and can identify games that can be launched on the host computer system 104 and streamed to the remote computer system 108. To identify the games, the dashboard 102 can scan storage locations in the host computer system 104 that are typically associated with games. For example, the dashboard 102 can scan a registry, file paths commonly associated with games, databases associated with games, and software libraries (e.g., DLLs) associated with games. In some implementations, the dashboard 102 can perform a heuristic search. The games identified by the dashboard 102 can include games stored on the host computer system 104 and games available through game streaming services such as Steam, Origin, UPlay and GOG Galaxy.

In 206, a network browser is initiated on a remote computer system. In implementations, a user can desire to remotely play a game on the remote computer system 108 that is available on the host computer 104. In 208, the network browser can navigate to the dashboard site. In implementations, the user can enter a network location name or network address associated with the dashboard 102. The client 110 can look-up the network address and establish a connection with the dashboard 102.

In 210, a graphic user interface (GUI) is generated including available game for play. The GUI generated by the dashboard 102 can include an indication (visual and/or textual) of the games available for remote play and an active link for a user initiate game play. For example, the games can be presented as cards in a grid, with a title related banner as the background of each, as discussed further below. The indication provided in the GUI can be an interactive widget that provides additional information about the game. For example, as a pointing device (e.g., cursor) hovers over one of the game cards, additional information can be presented, for example, the game title, a short description, playtime statistics, a slideshow of screenshots from the game, or a relevant video etc. The GUI, generated by the dashboard 102, can also include menus and links to access other features of the dashboard 102. The other features can include settings and configuration for the dashboard 102, controller settings for input, a game rating feature, a chat feature, etc.

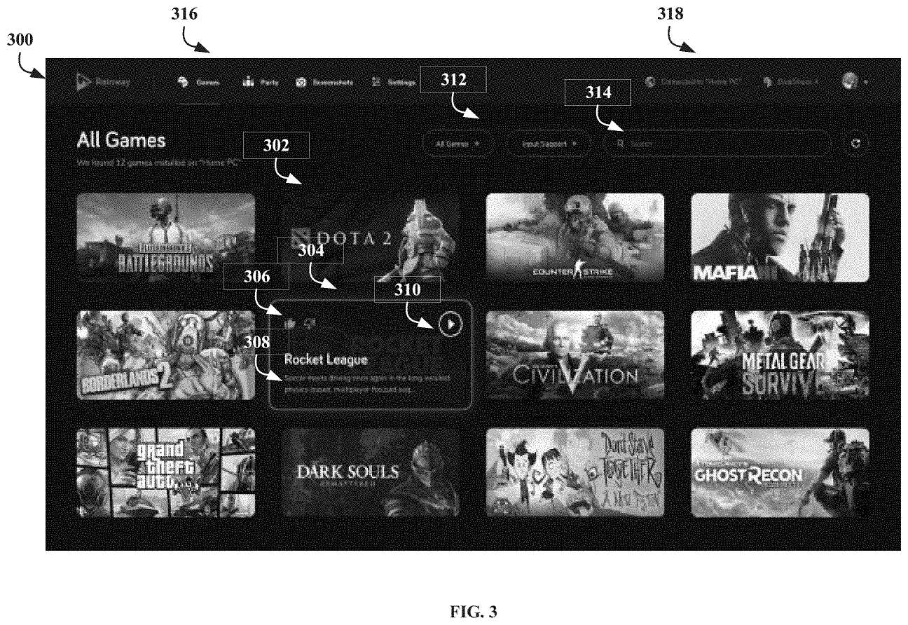

In 212, the GUI is provided to the remote computer system. In 213, the GUI is displayed in the network browser. For example, FIG. 3 illustrates an example of a GUI 300 for displaying and selecting games that are available for streaming, according to various implementations. As illustrated in FIG. 3, the GUI 300 can include game cards 302 that visually indicate the games that are available for remote play. The game cards 302 can include the title of the game and visual graphics associated with the game such as the title graphics. Once a user moves a pointer over or selects a game card, e.g., game card 304, additional information and options can be displayed. For example, the game card 304 can display a rating widget 306, a description 308, and a play button 310. The rating widget 306 can enable the user to enter a rating of the game such as thumbs up or thumbs down. The description 308 can include additional text description and instructions for the game. The launch button 310 can enable remote play of the game once selected.

The GUI 300 can also include a filter widget 312 and a search field 314. The filter widget 312 can enable the user to filter the games that are displayed in the GUI 300. The search field 314 can enable the user to enter text strings to search for specific games. The GUI 300 can also include navigation widgets 316 and information field 318. The navigation widgets 316 enable a user to access other features associated with the remote game play such as party gaming and chat, screenshots taken from game play, settings for the dashboard and game play, etc. The information field 318 can display details of the dashboard and gaming session such as the name of the host computer, a type of controller connected, etc.

Returning to FIG. 2, in 214, a selection of a game to play is received. For example, referring to FIG. 3, the user can selection the launch button for the game card 302 associated with the game the user desires to play. In 216, the game is launched on the host computer system. In implementations, the dashboard 102 can retrieve the launch and access parameters associated with the game to be played that were discovered in the identification process.

In 218, display frames and audio for the game are captured. In 220, a multimedia stream based is generated based on the captured display frames and audio. In implementations, once the game begins executing on the host computer system 104, the dashboard 102 can capture image data (e.g., image frames) that are transmitted to a display device (e.g., monitor) of the host computer system 104. Likewise, the dashboard 102 can capture audio data transmitted to audio devices (e.g., speakers, headphones, etc.) of the host computer system 104. As the image data and audio data is captured, the dashboard 102 can generate a game multimedia stream based on the captured image data and audio data. The encoding processes is described in further detail in Ser. No. 62/789,965, filed Jan. 8, 2019, the entire contents of which are incorporated herein by reference.

In implementations, the dashboard 102 can generate a remote encoding pipeline and prepares a video feed and an audio feed based on the captured image data and audio data. The dashboard 102 can generate a series of packets for the video feed and audio feed (multimedia stream) for transmission to the remote computer system 108. Once generated, the dashboard 102 can transmit the series of packets to the client 110, via the network 106.

In 222, the multimedia steam is presented in the network browser. In implementations, to receive the data, the remote computer system 108 can connect to the dashboard 102 using a media exchange protocol. In some implementations, the client 110 can connect to the dashboard 102 using WebRTC and can exchange data using WebRTC data channels. In some implementations, the client 110 can connect to the dashboard using Web Sockets.

As the packets are received, the client 110 can decode the packets and can reconstruct the video feed and audio feed using a media codex. In some implementations, the client 110 can forward the data to the MSE API. Once decoded, the client 110 can play the video on a display device (e.g., monitor, device screen, etc.) of the remote computer system 108 and can play the audio on an audio device (e.g., speaker, headphones, etc.) of the remote computer system 108.

In 224, input from the user is captured and transmitted to the host computer system. In 226, the captured input is translated to game input. In implementations, as the client 110 plays the video and audio stream, the user of the remote computer system 108 inputs movements as if the user was playing the game. The client 110 can capture the input device (e.g., keyboard, mouse, game controller, etc.) input from events (e.g., browser events). The client 110 can relay the input device input to the dashboard 102, and, in response, the dashboard 102 can apply the input device input directly to the game executing on the host computer system 104. In some implementations, if the client is a web browser, game controller input can be captured via the HTML version 5 gamepad API, and, at the remote computer system 108, a virtual controller can used to emulate the inputs on the host computer system 104. The input capture processes is described in further detail in Ser. No. 62/789,965, filed Jan. 8, 2019, the entire contents of which are incorporated herein by reference.

In 228, it is determined whether game play has ended. If game play has not ended, the method 200 returns to 218, and the dashboard continues to capture display frames and audio for the game in order to continue the multimedia stream and game play. If game play has ended, method 200 can end, repeat, or return to any point.

FIG. 4 illustrates an example of a method 400 for identifying games available for remote streaming, according to various implementations. While FIG. 4 illustrates various stages that can be performed, stages can be removed and additional stages can be added. Likewise, the order of the illustrated stages can be performed in any order.

In 402, a game scan is initiated. In some implementations, the game scan can be automatically initiated when the dashboard 102 is installed on the host computer system 104. In some implementations, the game scan can be automatically initiated when the dashboard 102 is launched on a host computer system 104. In some implementations, the game scan can be initiated by a user of the host computer system 104 and/or a user of a remote computer system 108.

In 404, storage locations associated with game data are searched. In implementations, the dashboard 102 can scans storage locations in the host computer system 104 that are typically associated with games. For example, the dashboard 102 can scan a registry, file paths commonly associated with games, databases associated with games, and software libraries (e.g., DLLs) associated with games.

In 406, it is determined whether a potential game is identified. In implementations, the dashboard 102 can compare data identified from the storage locations and compare the data to known example that correspond to games. In some implementations, the dashboard 102 can perform a heuristic analysis on the data identified from the storage location. For example, the dashboard 102 can identified a potential game based on the data identified from the storage location having features or structure that is typically of data associated with a game.

If a potential game is identified, in 408, launch parameters are determined from data associated with the potential game. In implementations, the dashboard 102 can retrieve the launch parameters from the registry or file path associated with the potential game. In 410, a human-readable title is determined form the data associated with the potential game. In implementations, the dashboard 102 can apply a text conversion algorithm on the data to generate a human-readable title.

In 412, information associated with the potential game is remotely fetched. In implementations, the dashboard 102 can search for the human-readable title on a remote database to determine if the human-readable title matches an actual game. In some implementations, the remote database can include a public search engine. In some implementations, the remote database can include a dedicated database that store game titles.

In 414, it is identified whether the potential game is an actual game available for play. If the potential game is not an actual game available for play, the potential game can be filtered out. If the potential game is an actual game available for play, the information associated with the identified game can be cached.

After, the method 400 proceeds to 404. Potential games can continue to be identified until all location have been searched. After the potential games have been identified and identified as actual games, in 420, fingerprints for the identified games are determined. In implementations, the fingerprints can include launch parameters and/or access information required to launch the game. In some implementation, the launch parameters can include one or more files required to launch the game (e.g., executable files). In some implementations, when the games identified by the dashboard 102 include games available through game streaming services such as Steam, Origin, UPlay and GOG Galaxy, access information can be required in order to launch. The dashboard 102 can generate a fingerprint that comprises all the access information and identification of files required to launch the game.

In 422, the fingerprints for the identified games are transmitted servers. In implementations, if a game requires remote access to launch, the dashboard can transmit the fingerprint to a remote server.

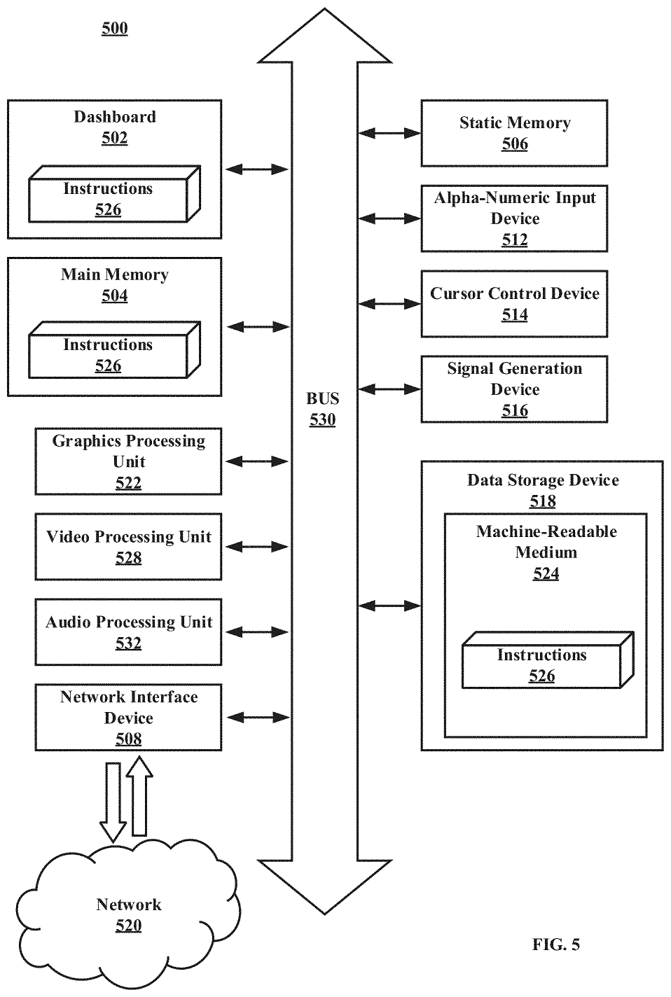

FIG. 5 illustrates an example machine of a computer system within which a set of instructions, for causing the machine to perform any one or more of the methodologies discussed herein, can be executed. In implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” also includes any collection of machines that individually or jointly execute a set (or multiple sets) of instructions to perform any one or more of the methodologies discussed herein.

The computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

The processing device 502 represents one or more general-purpose processing devices such as a microprocessor, a central processing unit, or the like. For example, the processing device can be complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computer system 500 further includes a network interface device 508 to communicate over the network 520. The computer system 500 also includes a video display unit 510 (e.g., a liquid crystal display (LCD) or a cathode ray tube (CRT)), an alphanumeric input device 512 (e.g., a keyboard), a cursor control device 515 (e.g., a mouse), a graphics processing unit 522, a signal generation device 516 (e.g., a speaker), graphics processing unit 522, video processing unit 528, and audio processing unit 532.

The data storage device 518 can include a machine-readable storage medium 524 (also known as a computer-readable medium) on which is stored one or more sets of instructions or software 526 embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media.

In implementations, the instructions 526 include instructions to implement functionality corresponding to the components of a device to perform the disclosure herein. While the machine-readable storage medium 524 is shown in an example implementation to be a single medium, the term “machine-readable storage medium” includes a single medium or multiple media (e.g., a centralized or distributed database, and/or associated caches and servers) that store the one or more sets of instructions. The term “machine-readable storage medium” also includes any medium that is capable of storing or encoding a set of instructions for execution by the machine and that cause the machine to perform any one or more of the methodologies of the present disclosure. The term “machine-readable storage medium” also includes, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “calculating” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices. Furthermore, to the extent that the terms “including”, “includes”, “having”, “has”, “with”, or variants thereof are used in the detailed description, such terms are intended to be inclusive in a manner similar to the term “comprising.” As used herein, the terms “one or more of” and “at least one of” with respect to a listing of items such as, for example, A and B, means A alone, B alone, or A and B. Further, unless specified otherwise, the term “set” should be interpreted as “one or more.” Also, the term “couple” or “couples” is intended to mean either an indirect or direct connection. Thus, if a first device couples to a second device, that connection can be through a direct connection, or through an indirect connection via other devices, components, and connections.

The present disclosure also relates to an apparatus for performing the operations herein. This apparatus can be specially constructed for the intended purposes, or it may comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), erasable programmable read-only memories (EPROMs), electrically erasable programmable read-only memories (EEPROMs), magnetic or optical cards, flash memory devices, or any type of media suitable for storing electronic instructions, each coupled to a computer system bus. Examples of implementations of the present disclosure can also be provided as a computer program product, or software, that may include a machine-readable medium having stored thereon instructions, which can be used to program a computer system (or other electronic devices) to perform a process according to the present disclosure.

Various general purpose systems can be used with programs in accordance with the teachings herein, or a more specialized apparatus can be utilized to perform the method. Examples of the structure for a variety of systems appear in the description above. In addition, the present disclosure is not described with reference to any particular programming language. It will be appreciated that a variety of programming languages may be used to implement the teachings of the disclosure as described herein.

A number of implementations have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps may be eliminated, from the described flows, and other components can be added to, or removed from, the described systems. Accordingly, other implementations are within the scope of the following claims.

What is claimed is:

1. A method for remotely playing a game over a network, the method comprising:
receiving, at a host computer system, a request to remotely play a video game at a remote computer system;
launching the video game on the host computer system;
capturing video frames and audio data generated for the video game;
generating a multimedia stream based on the video frames and audio data captured for the video game;
transmitting the multimedia to the remote computer system;
receiving, from the remote computer system, input data in response to the multimedia, wherein the input data corresponds to user interaction with multimedia stream; and
translating the input data to game input for the video game.

2. The method of claim 1, the method further comprising:
prior to receiving the request, identifying one or more video games available for play on the host computer system;
generating a graphical user interface that provides visual indications of the one or more video games available for play, wherein the visual indications comprise network links that initiate launching the one or more video games; and
providing the graphical user interface to the remote computer system.

3. The method of claim 2, wherein the graphical user interface is formatted to be displayed in a network browser on the remote computer system.

4. The method of claim 1, wherein capturing the video frames and audio data generated for the video game comprises:
capturing real-time video frames transmitted to a display device of the host computer system based on a frame rate of the multimedia stream; and
capturing real-time audio data transmitted to an audio device of the host computer system.

5. The method of claim 4, wherein generating the multimedia stream based on the video frames and audio data captured for the video game comprises:
buffering the real-time video frames captured for the video game; and
inserting one or more blank frames in the multimedia stream in response to the real-time video frames that are buffered not meeting the frame rate.

6. The method of claim 1, wherein generating the multimedia stream based on the video frames and audio data captured for the video game comprises:
generating a plurality of stateless packets based on the video frames and audio data captured for the video game.

7. The method of claim 1, wherein transmitting the multimedia stream to the remote computer system comprises:
establishing a real-time peer-to-peer connection with a network browser; and
transmitting the multimedia stream over the real-time peer-to-peer connection.

8. The method of claim 7, wherein the real-time peer-to-peer connection is established according to a Web Real-Time Communication protocol.

9. A computer readable medium storing instructions for causing one or more processors to perform a method for remotely playing a game over a network, the method comprising:
receiving, at a host computer system, a request to remotely play a video game at a remote computer system;
launching the video game on the host computer system;
capturing video frames and audio data generated for the video game;
generating a multimedia stream based on the video frames and audio data captured for the video game;
transmitting the multimedia to the remote computer system;
receiving, from the remote computer system, input data in response to the multimedia, wherein the input data corresponds to user interaction with multimedia stream; and
translating the input data to game input for the video game.

10. The computer readable medium of claim 9, the method further comprising:
prior to receiving the request, identifying one or more video games available for play on the host computer system;
generating a graphical user interface that provides visual indications of the one or more video games available for play, wherein the visual indications comprise network links that initiate launching the one or more video games; and
providing the graphical user interface to the remote computer system.

11. The computer readable medium of claim 10, wherein the graphical user interface is formatted to be displayed in a network browser on the remote computer system.

12. The computer readable medium of claim 9, wherein capturing the video frames and audio data generated for the video game comprises:
capturing real-time video frames transmitted to a display device of the host computer system based on a frame rate of the multimedia stream; and
capturing real-time audio data transmitted to an audio device of the host computer system.

13. The computer readable medium of claim 12, wherein generating the multimedia stream based on the video frames and audio data captured for the video game comprises:
buffering the real-time video frames captured for the video game; and
inserting one or more blank frames in the multimedia stream in response to the real-time video frames that are buffered not meeting the frame rate.

14. The computer readable medium of claim 9, wherein generating the multimedia stream based on the video frames and audio data captured for the video game comprises:
generating a plurality of stateless packets based on the video frames and audio data captured for the video game.

15. The computer readable medium of claim 9, wherein transmitting the multimedia stream to the remote computer system comprises:
establishing a real-time peer-to-peer connection with a network browser; and
transmitting the multimedia stream over the real-time peer-to-peer connection.

16. The computer readable medium of claim 15, wherein the real-time peer-to-peer connection is established according to a Web Real-Time Communication protocol.

17. A method for identifying games for remote play over a network, the method comprising:
scanning one or more storage locations associated with video games on a remote computer system;
identifying a potential video game based on the scan;
determining launch parameters from data associated with the potential video game;
determining a human-readable title from the data associated with the potential video game;
retrieving information associated with the potential video game based on the human-readable title and the launch parameters; and
identifying the potential video game as an actual video game based on the information retrieved from the potential video game.

18. The method of claim 15, wherein the one or more storage locations comprise a registry of the host computer system, common file location for a video game, databases associated with a video game, and software libraries associated with a video game.

19. The method of claim 15, wherein the scanning the one or more storage locations comprises a heuristic search.

20. The method of claim 15, the method further comprising:
generating a data fingerprint for the actual game; and
transmitting the fingerprint to a remote server.
